(19) United States
(12) Patent Application Publication
(10) Pub. No.: US 2020/0218304 A1
(43) Pub. Date: Jul. 9, 2020

(54) Butterfly Universal Temperature Profile

(71) Applicant: pSemi Corporation, San Diego, CA (US)

(72) Inventors: Harish Raghavan, San Diego, CA (US); Keith Bargroff, San Diego, CA (US); Anan Xiang, San Diego, CA (US)

(21) Appl. No.: 16/732,619

(22) Filed: Jan. 2, 2020

Related U.S. Application Data
(63) Continuation of application No. PCT/US2018/043576, filed on Jul. 24, 2018.
Application No. PCT/US2018/043576 is a continuation-in-part of application No. 15/659,389, filed on Jul. 25, 2017, now abandoned.

(51) Int. Cl. G05F 3/26

(52) U.S. Cl. CPC G05F 3/262

(57) ABSTRACT

Systems, methods, and apparatus for practical realization of a current source with a programmable temperature profile are described. The temperature profile can include profile segments with different programmable slopes. Programmable slopes of any one of the profile segments can be according to any of a ZTAT, PTAT and CTAT profiles. When integrated in an electronic device, the programmable temperature profile can be used statically with a pre-programmed configuration and optionally fused profile, or dynamically to control a performance of the electronic device via adjustments of the temperature profile.

### CROSS-REFERENCE TO RELATED APPLICATIONS

The present application is a continuation of PCT application No. PCT/US2018/043576, filed on Jul. 24, 2018, which, in turn, is a continuation in part of U.S. patent application Ser. No. 15/659,389, filed on Jul. 25, 2017 and entitled “Butterfly Universal Temperature Profile”, now abandoned, the disclosures of all of which are incorporated herein by reference in their entirety.

The present application may also be related to U.S. patent application Ser. No. 15/258,806, entitled “Universal RF Amplifier Controller” (Attorney Docket No. PER-186-PAP), filed on Sep. 7, 2016, the disclosure of which is incorporated herein by reference in its entirety.

### TECHNICAL FIELD

The present application generally relates to electronic circuits, and more specifically to systems, methods and devices for use in current generation circuits that can provide temperature compensated biasing currents.

### BACKGROUND

Traditionally, current generation circuits that provide biasing currents to electronic devices have been designed with fixed temperature profiles to compensate for device sensitivity with respect to temperature variation. Such fixed temperature profiles may include a proportional to absolute temperature (PTAT) profile, a complementary proportional to absolute temperature (CTAT) profile, a zero-proportionality to absolute temperature (ZTAT) profile, or a combination thereof. Applications like RF Amplifiers need temperature compensated currents to achieve the required performance. When using fixed temperature profiles, such systems are optimized iteratively by way of in-system testing, where each iteration includes generation of a new chip comprising an updated temperature profile. As performance of electronic devices are subject to variations due, for example, to variation in processing (manufacturing), voltage, temperature, or other factors, optimization of the fixed temperature profile can be seen as a moving target which can require continued sustaining engineering. In addition, as components of electronic devices age, a corresponding performance drift with respect to temperature of the electronic devices may not be compensated for by the fixed temperature profiles. Furthermore, traditional PTAT and ZTAT profiles have a single control relationship (i.e., slope of a control parameter versus temperature) over the system's entire temperature range, whereas it is often necessary to have more than one slope in temperature subranges. It is therefore desirable to provide a current generation circuit that can address some or all of the above problems associated with the fixed temperature profiles.

### SUMMARY

According to a first aspect of the present disclosure, a current generator circuit with programmable temperature profile over a temperature range of operation is presented, the current generator circuit comprising: a first single slope current source having a single slope temperature profile over the temperature range of operation; a flat current source having a flat temperature profile over the temperature range of operation; wherein the current generator circuit is configured to generate the programmable temperature profile based on combinations of currents from the first single slope current source and the flat current source, the programmable temperature profile having at least one inflection point at a reference temperature that defines a first programmable slope for temperatures below the reference temperature and a second programmable slope that is independent from the first programmable slope for temperatures above the reference temperature.

According to a second aspect of the present disclosure, a method for generating a programmable temperature profile over a temperature range of operation is presented, the method comprising: providing a first single slope current source having a single slope temperature profile over the temperature range of operation; providing a flat current source having a flat temperature profile over the temperature range of operation; combining currents from the first single slope current source and the flat current source; and based on the combining, generating the programmable temperature profile having at least one inflection point at a reference temperature that defines a first programmable slope for temperatures below the reference temperature and a second programmable slope that is independent from the first programmable slope for temperatures above the reference temperature.

The details of one or more embodiments of the invention are set forth in the accompanying drawings and the description below. Other features, objects, and advantages of the invention will be apparent from the description and drawings, and from the claims.

### DESCRIPTION OF THE DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1A shows a block diagram of an exemplary prior art bias current generation circuit with temperature compensation according to a fixed temperature profile.

FIG. 1B shows a block diagram of an exemplary bias current generation circuit according to the present disclosure with temperature compensation according to a programmable temperature profile.

FIG. 2A shows a zero-proportionality to absolute temperature (ZTAT) profile as known in the art, where a current output is substantially constant over a temperature range of operation.

FIG. 2B shows a proportional to absolute temperature (PTAT) profile as known in the art, where a current output monotonously increases with a temperature increase over a temperature range of operation according to a curve with a substantially constant positive slope.

FIG. 2C shows a complementary to absolute temperature (CTAT) profile as known in the art, where a current output monotonously decreases with a temperature increase over a temperature range of operation according to a curve with a substantially constant negative slope.

FIG. 2D shows superimposed 2-part temperature profiles with different slopes, all passing through a same current value at a reference temperature.

FIGS. 3A, 3B and 3C each show 2-part temperature profiles obtained through proper control of a combination of the ZTAT, PTAT and CTAT temperature profiles.

FIG. 4A shows a simplified block diagram of a butterfly temperature profile generation circuit according to an embodiment of the present disclosure capable of generating 2-part temperature profiles depicted in FIGS. 3A, 3B and 3C.

FIG. 4B shows a simplified block diagram of an exemplary butterfly temperature profile generation circuit based on the block diagram depicted in FIG. 4A.

FIG. 4C shows a simplified block diagram of a butterfly temperature profile generation circuit according to an embodiment of the present disclosure based on the block diagram of FIG. 4A, with an added optional slope selector block for selection of a single slope temperature profile or a 2-part temperature profile with different slopes.

FIG. 4D shows a simplified block diagram of a butterfly temperature profile generation circuit according to an embodiment of the present disclosure based on the block diagram of FIG. 4C, where slope adjustment of the single slope temperature profile can be provided separately from the slope adjustment of the different slopes of the 2-part temperature profile.

FIGS. 5A and 5B show exemplary operations over elementary units of current sources for generation of temperature profiles with different slopes.

FIGS. 6A and 6B show exemplary operation of a basic quadrant extraction circuit according to an embodiment of the present disclosure.

FIG. 6C shows an exemplary operation of a basic quadrant combinator circuit according to an embodiment of the present disclosure.

FIG. 6D shows an exemplary operation of a basic quadrant combinator and slope adjuster circuit according to an embodiment of the present disclosure.

FIG. 7 shows a programmable temperature profile according to an exemplary embodiment of the present disclosure having two separate inflection points.

FIG. 8 is a process chart showing various steps of a method for generating a programmable temperature profile over a temperature range of operation, according to an embodiment of the present disclosure.

Like reference numbers and designations in the various drawings indicate like elements.

### DETAILED DESCRIPTION

Throughout the present disclosure, embodiments and variations are described for the purpose of illustrating uses and implementations of inventive concepts of various embodiments. The illustrative description should be understood as presenting examples of the inventive concept, rather than as limiting the scope of the concept as disclosed herein.

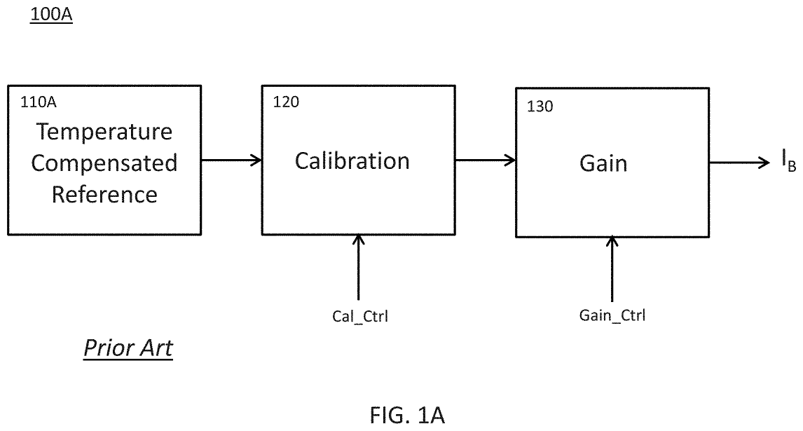

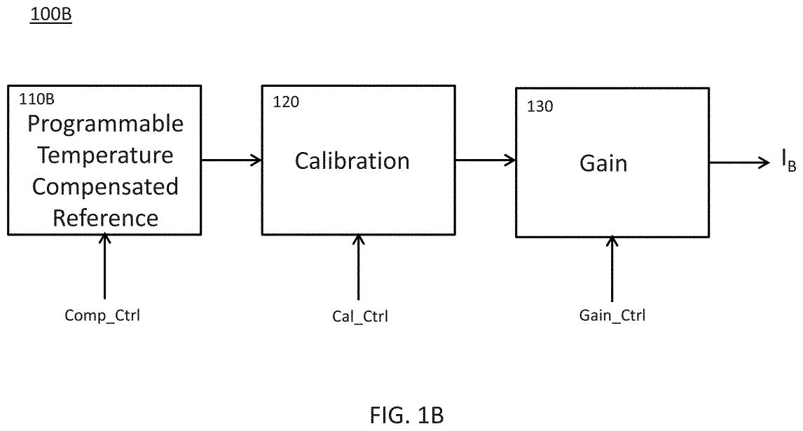

FIG. 1A shows a simplified block diagram of an exemplary prior art bias current generation circuit (100A) with temperature compensation according to a fixed temperature profile. A temperature compensated reference (circuit) block (110A) provides a reference current according to a desired fixed temperature profile typically set by physical characteristics embedded in an IC (and therefore unchangeable). The reference current may be calibrated through block (120) via, for example, a control signal Cal_Ctrl, and further amplified through block (130) via, for example, a control signal Gain_Ctrl, where each of the calibration and amplification may be performed during same or different manufacturing and usage steps of the circuit (100A), as described, for example, in the above referenced U.S. patent application Ser. No. 15/258,806, the disclosure of which is incorporated herein by reference in its entirety. The calibrated, amplified and temperature compensated output current I_{B} of the current generation circuit (100A) can be provided to an electronic device, such as, for example, a radio frequency (RF) amplifier, to control an output power of the device and maintain a desired characteristic of the output power in view of device sensitivity to temperature variation.

As described above, by virtue of providing a fixed temperature profile, any desired change to the profile should be accompanied with generation of a new integrated circuit, thereby affecting development time and cost associated with initial profile generation phase for system optimization, ensuing manufacturing and production phase in view of variation in components and process control, and end user phase where sub-optimal system performance may be obtained due to inadequate temperature profile with respect to component aging. It follows that the teachings according to the present disclosure provide systems, methods and devices to address shortcomings provided by a temperature compensation circuit with fixed temperature profile

FIG. 1B shows a simplified block diagram of an exemplary bias current generation circuit (100B) with temperature compensation according to a programmable temperature profile. A temperature compensated reference block (110B) according to an embodiment of the present disclosure provides a reference current according to a programmable temperature profile. Programming of a desired temperature profile may be provided via a control signal Comp_Ctrl. The reference current may be calibrated and further amplified through blocks (120, 130) as discussed above with reference to FIG. 1A, and further described, for example, in the above referenced U.S. patent application Ser. No. 15/258,806, the disclosure of which is incorporated herein by reference in its entirety.

By virtue of being programmable, dynamic generation of temperature profiles for the temperature compensated reference block (110B) is possible. In turn, this can allow speed and flexibility in generating a desired profile during any utilization step of the circuit (100B). For example, a same integrated circuit (100B) may be provided for a variety of different target systems where specific profiles may be pre-programmed (e.g. using configuration registers, memory), and optionally locked via a fuse block, during a final testing/alignment step of the circuit (100B). In another example, when integrated with an electronic device, such as, for example, an RF amplifier, dynamic generation of different temperature profiles may be used to quickly identify a temperature profile for an optimal or desired performance of the electronic device over a range of temperatures. Such optimal or desired performance over the range of temperatures may be maintained in spite of components' aging of the electronic device by dynamically providing corresponding adjustments to the temperature profile.

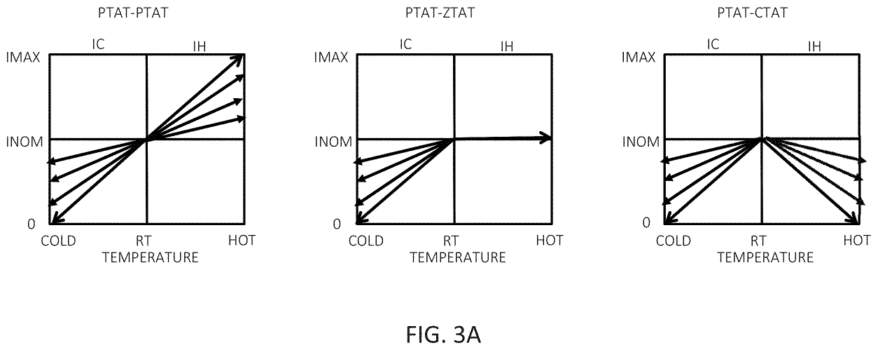

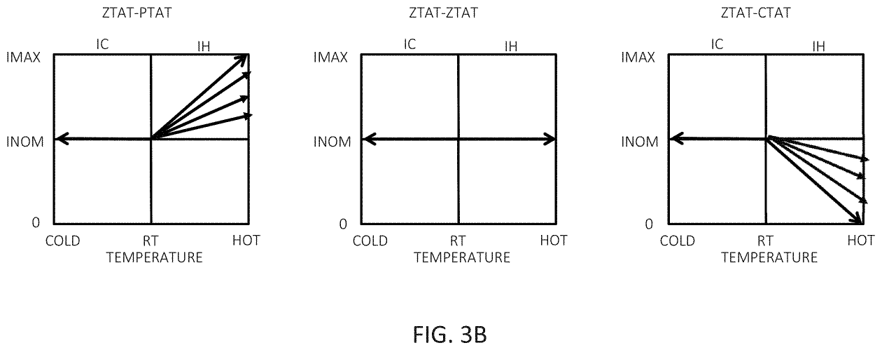

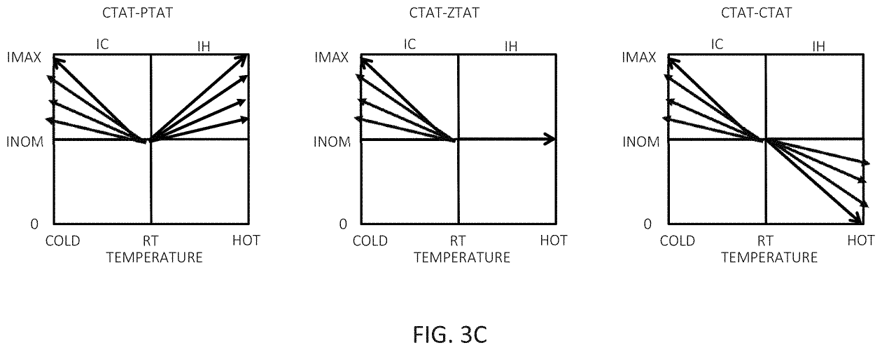

According to an embodiment of the present disclosure, the programmable temperature profile according to the present disclosure can provide profiles based on a combination of one or more of a ZTAT, PTAT and CTAT temperature profiles. According to an exemplary embodiment of the present disclosure, a programmed temperature profile may follow any one of the ZTAT, PTAT and CTAT over a temperature range above a reference temperature (denoted RT in the various figures of the present application), and may follow any one of the ZTAT, PTAT and CTAT over a temperature range below the reference temperature, thereby potentially creating an inflection point at the reference temperature, RT (e.g. FIGS. 3A, 3B, 3C later described). Although the reference temperature may be any arbitrary temperature value, a person skilled in the art would know that usually this temperature is associated to “room” temperature and represents a nominal ambient temperature for operation of an electronic device. It should be noted that a person skilled in the art is well aware of the ZTAT, PTAT and CTAT temperature profiles and associated circuits, some of which are described, for example, in the above referenced U.S. patent application Ser. No. 15/258,806, the disclosure of which is incorporated herein by reference in its entirety.

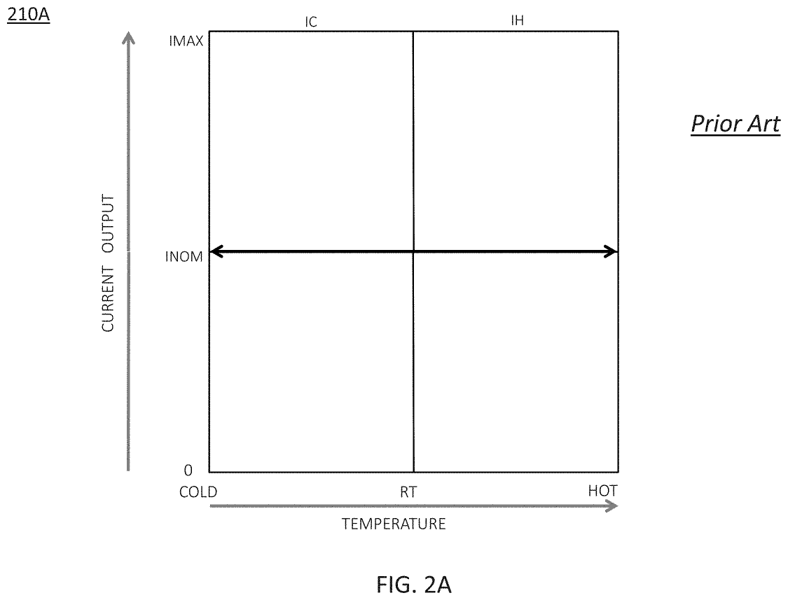

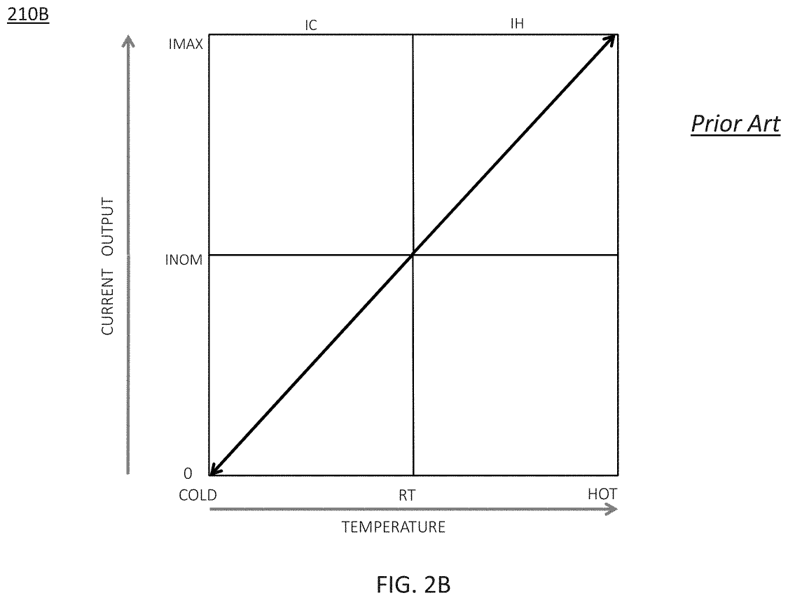

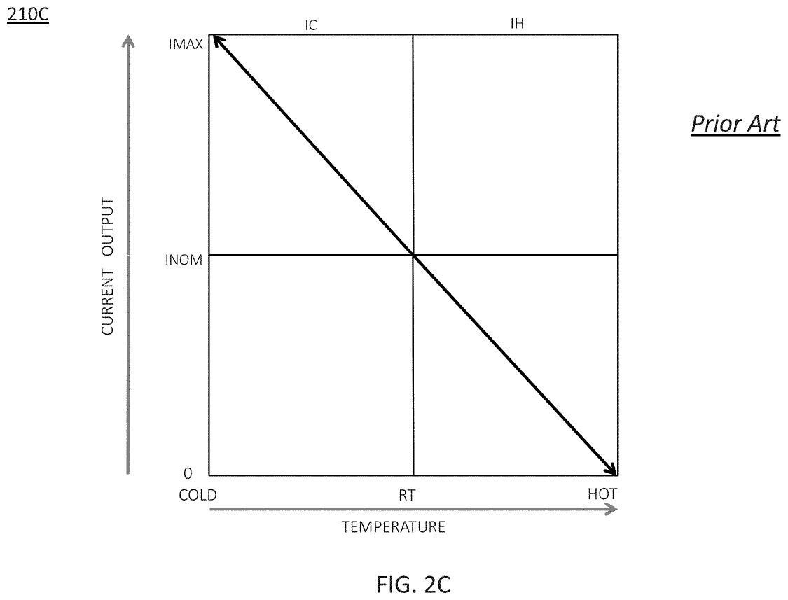

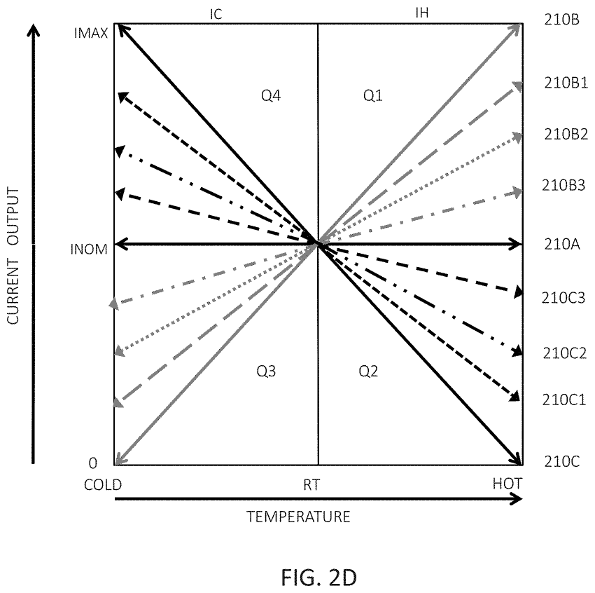

The ZTAT profile (210A) shown in FIG. 2A provides a current output that is substantially constant over a temperature range of operation, delimited by a low temperature COLD and a high temperature HOT. Over the entire temperature range of operation, ZTAT current output remains substantially constant at a nominal value denoted INOM.

The PTAT profile (210B) shown in FIG. 2B provides a current output that monotonically increases with a temperature increase over the entire temperature range of operation according to a curve with a substantially constant positive slope. In the exemplary case depicted in FIG. 2B, the current output is at the nominal value INOM at the reference temperature RT, at a zero value, denoted 0, at the lower temperature, COLD, of the temperature range, and at a high value, denoted IMAX, at the higher temperature, HOT, of the temperature range.

The CTAT profile (210C) shown in FIG. 2C provides a current output that monotonically decreases with a temperature increase over the entire temperature range of operation according to a curve with a substantially constant negative slope. In the exemplary case depicted in FIG. 2C, the current output is at the nominal value INOM at the reference temperature RT, at the zero value at the higher temperature, HOT, of the temperature range, and at the high value IMAX, at the lower temperature, COLD, of the temperature range.

FIG. 2D shows superimposed ZTAT, PTAT and CTAT temperature profiles (210A, 210B, 210C) of FIGS. 2A, 2B and 2C, and additional PTAT (210B1, 210B2, 210B3) and CTAT (210C1, 210C2, 210C3) which have slopes different from the PTAT (210B) and CTAT (210C). As can be seen in FIG. 2D, all the temperature profiles pass through a point defined by (INOM, RT), and in combination, they represent the shape of a butterfly (wings). A person skilled in the art would realize that a temperature profile over the entire temperature range [COLD, HOT] can be divided to a profile segment, IH, corresponding to a temperature range above the reference temperature RT, and a profile segment, IC, corresponding to a temperature range below the reference temperature RT. Also, as can be seen in FIG. 2D, each one of the profile segments IH and IC may operate at a current output that is either above or below the nominal value INOM, at the exception of the two segments corresponding to the ZTAT profile that operate at the nominal value INOM. Accordingly, and as can be seen in FIG. 2D, the profile segments can map into any of four quadrants Q1, Q2, Q3 and Q4, with profile segments IH mapping into one of Q1 and Q2, and profile segments IC mapping into one of Q3 and Q4.

With further reference to the profile segments depicted in FIG. 2D, a programmable butterfly temperature profile according to the present disclosure can provide any one profile segment IH in combination with any one profile segment IC, as shown in FIGS. 3A, 3B and 3C. It should be noted that although the exemplary combined butterfly profile depicted in FIG. 2D is shown to be generated with one ZTAT profile (210A), four PTAT profiles (210B, 210B1, 210B2, 210B3) and four CTAT profiles (210C, 210C1, 210C2, 210C3), other combined butterfly profiles including more or less variations (with respect to slopes) of the PTAT and CTAT profiles are also possible, and therefore the configuration depicted in FIG. 2D should not be considered as limiting the scope of the present teachings.

FIGS. 3A, 3B and 3C each show three different basic temperature profiles obtained through combination of any two profile segments IC and IH of FIG. 2D. As described above, each of such profile segments is based on one of a ZTAT, PTAT or CTAT temperature profiles over a temperature range that is either below or above the reference temperature RT. Accordingly, nomenclature used for the different basic temperature profiles depicted in FIGS. 3A, 3B and 3C describe related component segments. For example, FIG. 3A shows a PTAT-PTAT temperature profile where the profile segment IC is based on a PTAT profile and the profile segment IH is also based on a PTAT profile. As can be seen in the PTAT-PTAT temperature profile of FIG. 3A, any of a plurality of different slopes can be provided for either the segment IC or the segment IH.

The profile segment IC of the PTAT-ZTAT temperature profile depicted in FIG. 3A is based on a PTAT profile and the profile segment IH is based on the ZTAT profile. Accordingly, any of the plurality of different slopes can be provided for the profile segment IC of the PTAT-ZTAT temperature profile and only one segment of constant value can be provided as the IH profile segment. A person skilled in the art would clearly understand composition of the PTAT-CTAT, ZTAT-PTAT, ZTAT-ZTAT, ZTAT-CTAT, CTAT-PTAT, CTAT-ZTAT and CTAT-CTAT basic temperature profiles depicted in FIGS. 3A, 3B and 3C. The nine basic temperature profiles depicted in FIGS. 3A, 3B and 3C can be provided by the programmable butterfly temperature profile according to the present teachings. In addition, slope adjuster for each of corresponding profile segments IH and IC may be provided in cases where the segments are not according to the ZTAT profile.

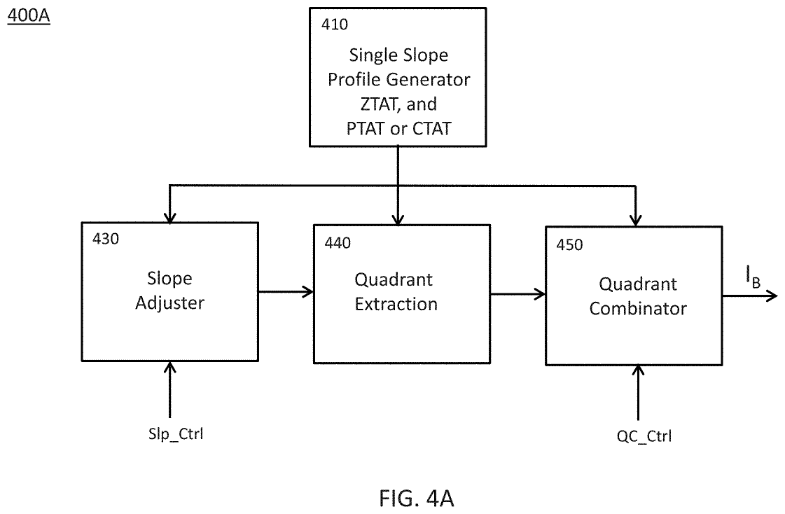

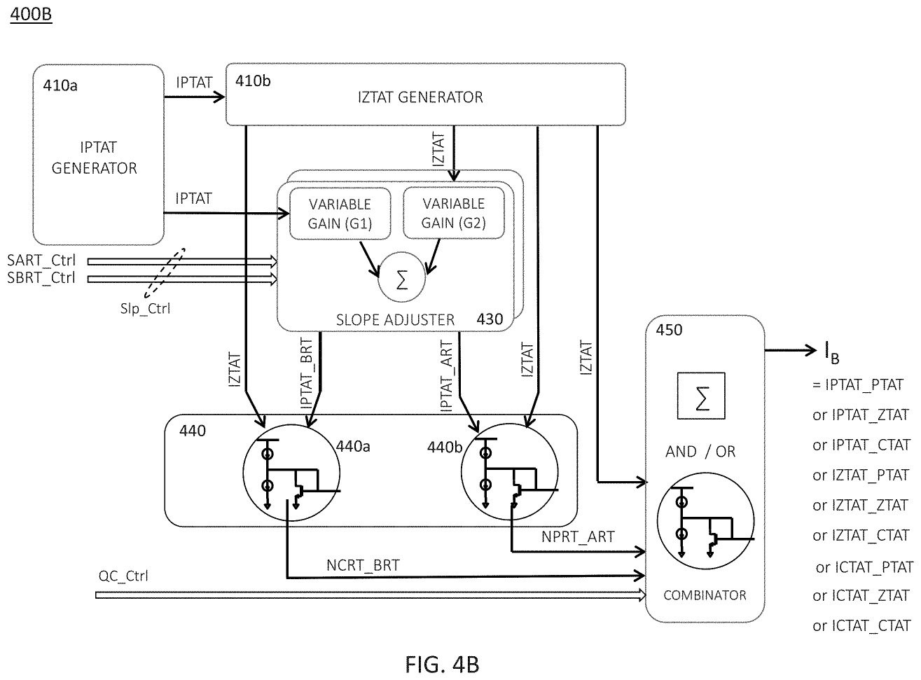

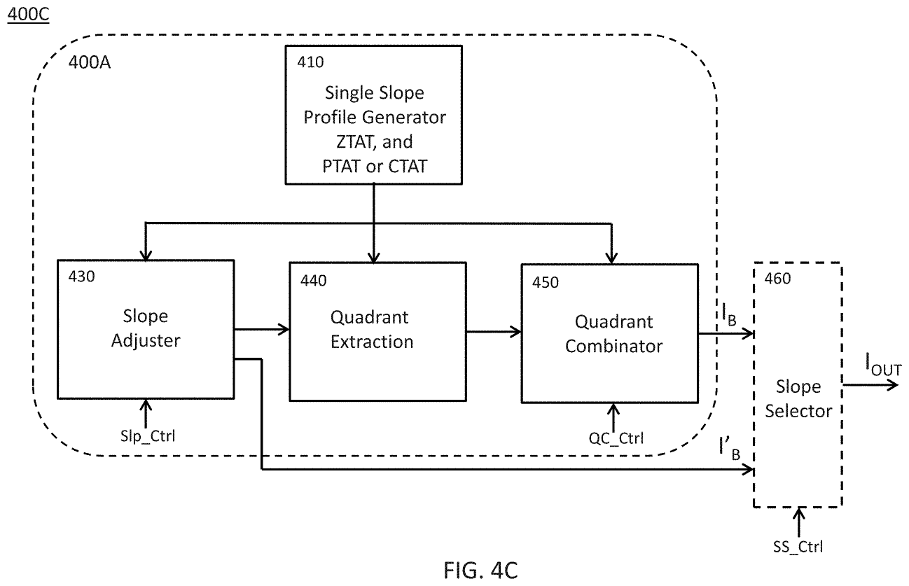

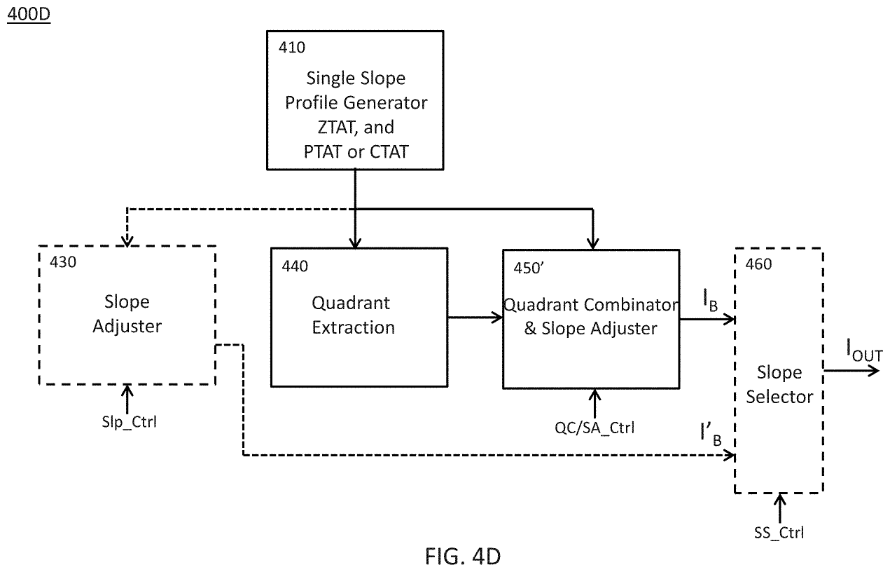

FIG. 4A shows a simplified block diagram (400A) of a butterfly temperature profile generation circuit according to an embodiment of the present disclosure. A single slope profile generator block (410) can generate current sources that provide the ZTAT, PTAT and CTAT temperature profiles, as shown, for example, in FIGS. 2A, 2B and 2C. A person skilled in the art is well aware of design techniques for designing such current source circuits, which are therefore not described in the present disclosure. In some embodiments, the current source circuits may be sized to provide a same output current (e.g. INOM) at a reference temperature (e.g. RT), and may be further ratio-metrically related so that the currents can track one another in dependence of temperature variation. Currents generated by the single slope profile generator block (410) are provided to each of the other blocks (430, 440, 450) for further processing.

According to one exemplary embodiment of the present disclosure, the single slope current generator (410) may comprise a current source according to one of the PTAT and CTAT profiles, and generate therefrom the ZTAT profile (e.g. via compensation/adjustment). In the exemplary non-limiting embodiments described in the flowing paragraphs, a butterfly temperature profile generation circuit with a single slope profile generator block based on PTAT and ZTAT temperature profiles is described. A person skilled in the art would be able to use the present teachings to generate similar butterfly temperature profiles based on, for example, (PTAT, ZTAT), or (CTAT, ZTAT), or (PTAT, CTAT, ZTAT) temperature profiles.

With further reference to the block diagram (400A), the slope adjuster block (430) can generate single slope profiles of varying slopes based on the provided single slope PTAT and/or CTAT profiles (from block 410), as exemplified, for example, by PTAT profiles (110B1, 110B2, 110B3) and CTAT profiles (110C1, 110C2, 110C3) depicted in FIG. 2D. According to an exemplary embodiment of the present disclosure, slope adjustment may be provided by combining (e.g. summing) appropriate current portions, relative to a size of the current sources generated in block (410), having one of the PTAT and/or CTAT profiles with current portions having the ZTAT profile. For example, by combining out of a total four portions, four portions of PTAT and zero portions of ZTAT, same PTAT profile is obtained. By combining three portions of PTAT and one portion of ZTAT, a PTAT profile with a slope that is 75% the slope of the provided PTAT is obtained. By combining two portions of PTAT and two portions of ZTAT, a PTAT profile with a slope that is 50% the slope of the provided PTAT is obtained. By combining one portion of PTAT and three portions of ZTAT, a PTAT profile with a slope that is 25% the slope of the provided PTAT is obtained. By combining zero portions of PTAT and four portions of ZTAT, a PTAT profile with a slope that is 0% the slope of the provided PTAT is obtained.

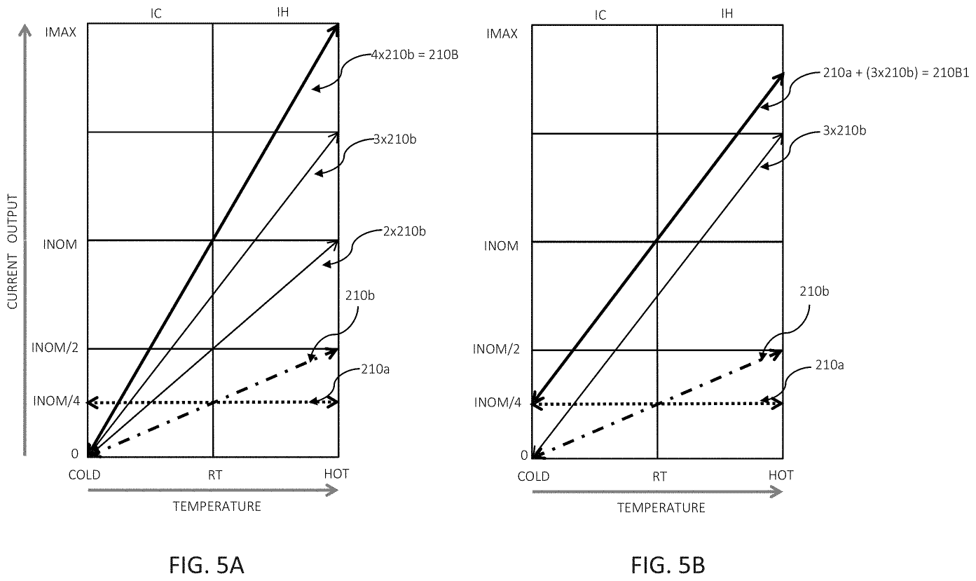

Operation of the slope adjuster block (430) is exemplified in FIG. 5A showing generation of a PTAT profile having a slope of 100% obtained by combining four portions of elementary units PTAT, and in FIG. 5B showing generation of a PTAT profile having a slope of 75% obtained by combining three portions of elementary units PTAT and one portion of elementary unit ZTAT, where it is assumed that the current sources that generate the ZTAT and PTAT profiles have a size of four units, represented by elementary units (210a) and (210b) for respective sources generating ZTAT (210A of FIG. 2A) and PTAT (210B of FIG. 2B) profiles. In the exemplary cases depicted in FIGS. 5A and 5B, it is assumed that the high value IMAX of the current output is twice the nominal value INOM of the current output (i.e. IMAX=2×INOM).

With reference to FIG. 5A, operations over the elementary units (210a) and (210b) for generation of the PTAT profile (210B) are shown. By summing four instances of the elementary unit (210b) and zero instances of the elementary unit (210a), the PTAT profile (210B) is generated. Similarly, as shown in FIG. 5B, by summing three instances of the elementary unit (210b) and one instance of the elementary unit (210a), the PTAT profile (210B1) is generated. Based on this, a person skilled in the art would clearly understand operation of the slope adjuster block (430).

More or less granularity in the slope adjustment of the block (430) can be achieved by providing more choices of the possible proportions (for example, by considering smaller elementary units and/or considering non-integer multiplication of the elementary units). Similarly, if desired, CTAT profiles with varying slopes can be provided by combining appropriate current portions of the provided CTAT with appropriate current portions of the provided ZTAT. A control signal Slp_Cntrl to the slope adjuster block can describe a desired level of slope adjuster (e.g. summing operation). Such slopes are based on a desired output current I_{B} temperature profile according to one of the butterfly profiles depicted in FIGS. 3A, 3B, 3C, and include a slope for the corresponding profile segment IH for above reference (e.g. RT) temperatures, and a slope for the corresponding profile segment IC for below reference temperatures.

In some applications, a single slope temperature profile as provided by the slope adjuster (430) may be sufficient. It follows that according to an embodiment of the present disclosure, and as shown in the simplified block diagram (400C) of FIG. 4C, an optional (shown in broken lines) slope selector block (460) may be added to the block diagram (400A) of FIG. 4A so to allow selection between an adjustable single slope temperature profile generated by the slope adjuster (430) and the butterfly temperature profile generated by the block diagram (400A). A current I′_{B} having the single slope temperature profile is output by the slope adjuster (430) and provided, along with the current I_{B} output by the butterfly temperature profile generation circuit represented by the block diagram (400A), to the slope selector block (460). A control signal SS_Ctrl can be used to select an output current, I_{OUT}, between the currents I′_{B} and I_{B}. A person skilled in the art would know of many exemplary circuit designs for the slope selector block (460), which are beyond the scope of the present disclosure. It should be noted that although the simplified block diagram (400C) of FIG. 4C shows separate outputs of the slope adjuster block (430) respectively feeding the quadrant extraction block (440) and the slope selector block (460), a person skilled in the art would clearly realize that same or common outputs of the slope adjuster block (430) may feed both the blocks (440) and (460).

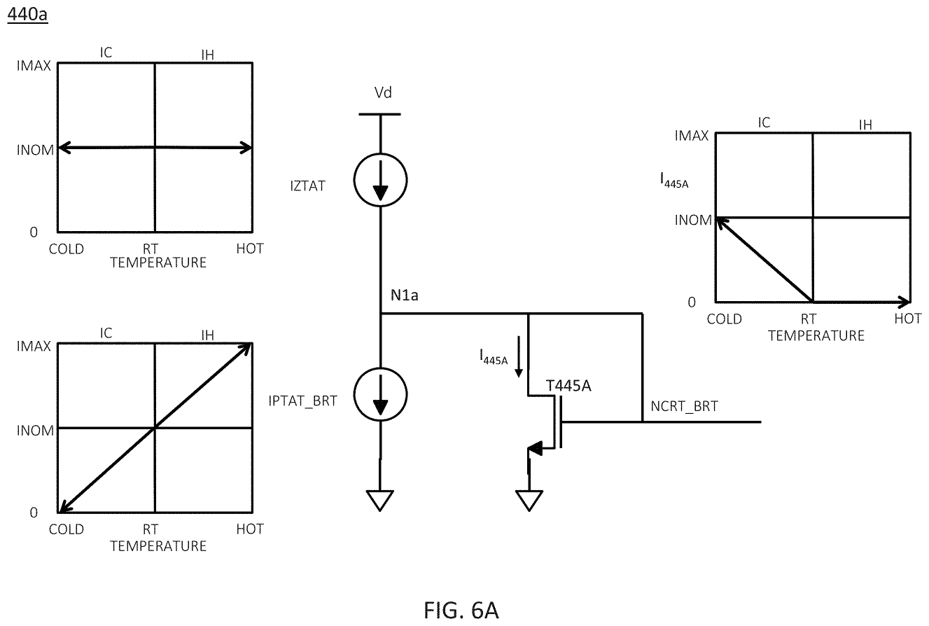

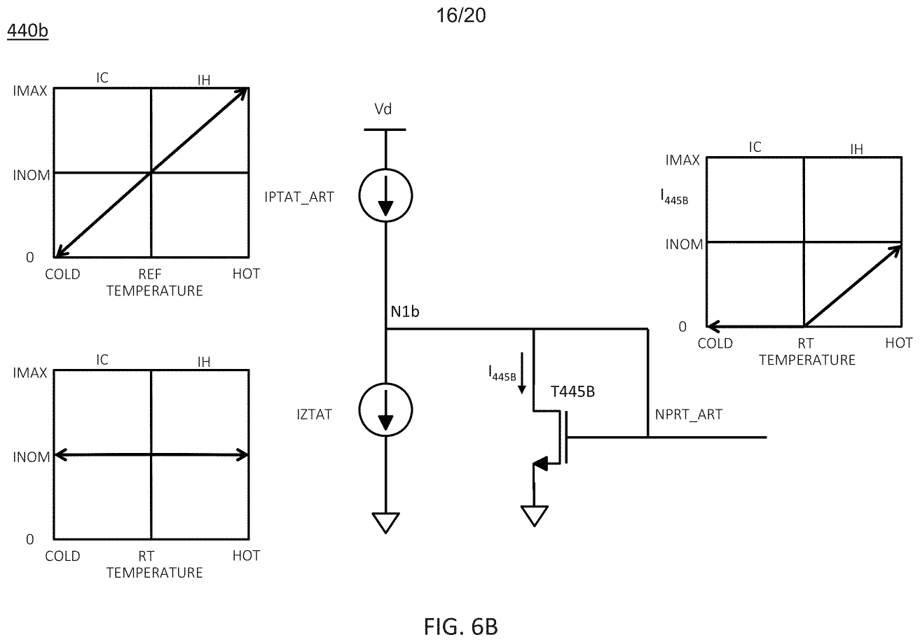

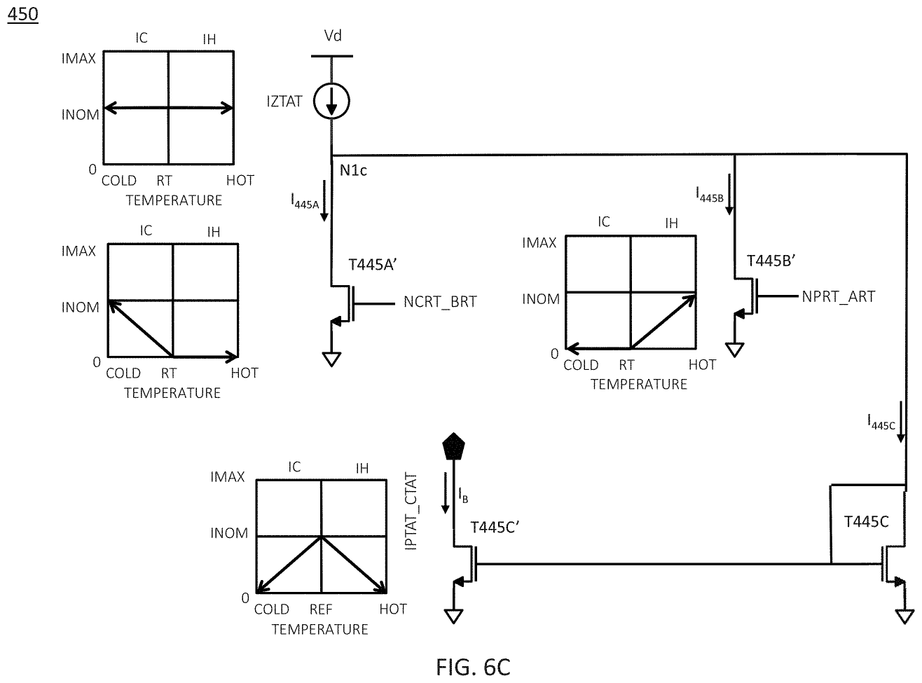

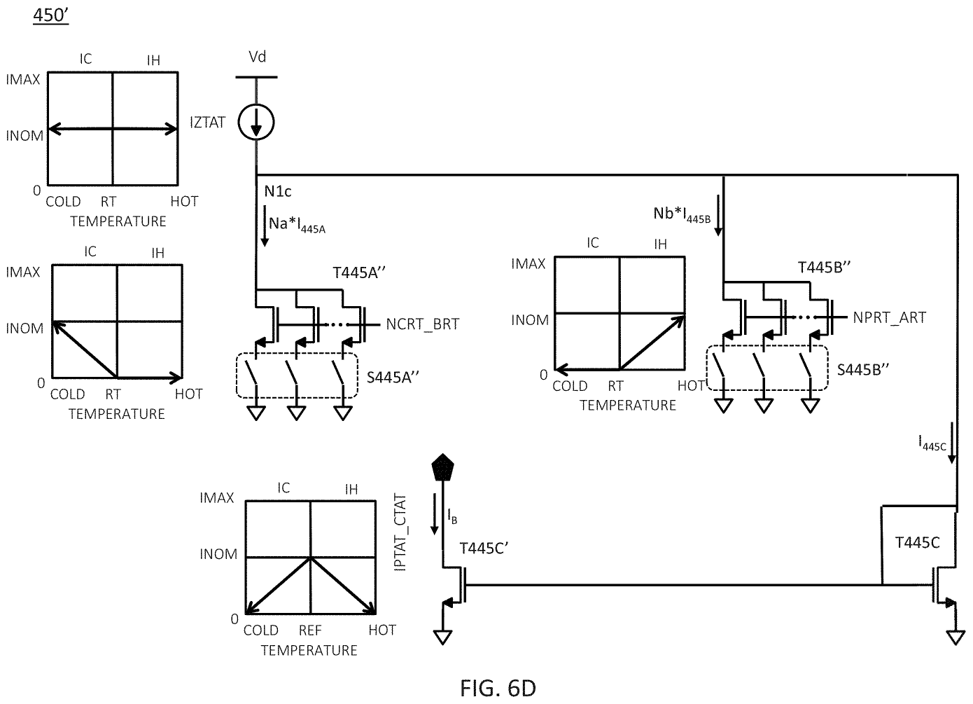

With continued reference to the block diagram (400A) of FIG. 4A, PTAT (and/or CTAT depending on the configuration of block 410) currents with adjusted slope profiles by the slope adjuster block (430), and IZTAT current from block (410), are provided to a quadrant extraction block (440) which is configured to extract the IC and IH segment profiles. More specifically, for each of the profile segments IC and IH of the output current I_{B}, a PTAT current with an adjusted slope corresponding to a desired slope of the output current I_{B} is provided, by the slope adjuster block (430), independently of the other profile segment. The quadrant extraction block (440) extracts the profile segment IC and the profile segment IH and provides these segments to the quadrant combinator block (450) which combines the profiles to provide the output current I_{B}. A control signal QC_Ctrl to the quadrant combinator block (450) controls operations performed on the extracted profile segments IC and IH that are input to the block (450) such as to map the extracted segments into the appropriate quadrants Q1-Q4. More details on the operation of the quadrant extraction block (440) and the quadrant combinator block (450) are described below as related to FIGS. 6A, 6B and 6C for a case where the single slope profile generator (410) acts upon PTAT and ZTAT current profiles.

As described above with reference to FIGS. 4A, 5A and 5B, currents with respective adjusted slopes for each of the profile segments IC and IH can be provided by the slope adjuster block (430). Also, as shown in FIG. 4C, if a single slope temperature profile is desired, the slope adjuster block (430) can provide such profile without intervention of the quadrant extraction block (440) and the quadrant combinator block (450). According to an embodiment of the present disclosure, and as shown in the simplified block diagram (400D) of FIG. 4D, adjustment of the slopes for each of the profile segments IC and IH may be performed after operation of the quadrant extraction block (440), and in combination with the operation of the quadrant combinator block, by a quadrant combinator & slope adjuster block (450′). Further details of the operation of the block (450′) is later provided with reference to FIG. 6D.

FIG. 4B shows a simplified block diagram (400B) of an exemplary butterfly temperature profile generation circuit based on the block diagram depicted in FIG. 4A. In the exemplary implementation depicted in FIG. 4B, the single slope profile generator block (410) of FIG. 4A comprises a block (410a) that generates a current with PTAT profile, and a block (410b) that generates a current with ZTAT profile based on the current output by the block (410a). A person skilled in the art would understand that such configuration using a reference current with PTAT profile to generate a slave current with ZTAT profile is a mere design choice, and should therefore not be used as limiting the scope of the present teachings.

With further reference to FIG. 4B, the slope adjuster block (430) provides slope adjustments based on operation over currents output by blocks (410a) and (410b) as described above with reference to FIG. 5A and FIG. 5B. In the exemplary non-limiting implementation depicted in FIG. 4B, only currents with PTAT and ZTAT profiles are used by the slope adjuster block (430) which are used, in combination, to generate a first current IPTAT_BRT having a PTAT profile with a slope corresponding to a desired slope of the profile segment IC of the output current I_{B}, and a second current IPTAT_ART having a PTAT profile with a slope corresponding to a desired slope of the profile segment IH of the output current I_{B}. Programming of the slopes of the IPTAT_ART and IPTAT_ BRT currents can be provided via the Slp_Ctrl signal having, for example, separate control signals SART_Ctrl and SBRT_Ctrl respectively.

With continued reference to FIG. 4B, the currents output by the slope adjuster block (430) along with the current IZTAT having the ZTAT profile generated by the block (410b), are fed to the quadrant extraction block (440) which comprises two independent and similar circuits (440a) and (440b), each for extraction of a slope corresponding to one of the profile segments IC and IH for generation of the profile of the output current I_{B}. Operation of the circuits (440a) and (440b) based on exemplary slopes of the current profiles of IPTAT_BRT and IPTAT_ART is shown in FIG. 6A and FIG. 6B respectively.

With reference to FIG. 6A, the currents IZTAT and IPTAT_BRT provided to the circuit (440a) are made to be in series connection through a common node N1a. A person skilled in the art would know of many ways to create such series connected currents, including usage of current mirrors to mirror the provided currents IZTAT and IPTAT_BRT and operating on the mirrored currents to create the series connected currents. A diode connected transistor T445A (e.g. N-type MOSFET) coupled to the common node N1a determines direction of a current (I_{445A}) out of the common node N1a and through the transistor. A person skilled in the art would realize that I_{445A} is non-zero only when the current IZTAT is larger than the current IPTAT_BRT. Therefore, for temperatures in the range of [RT, HOT], the current I_{445A} through the diode connected transistor T445A is zero since IZTAT is smaller or equal to IPTAT_BRT in said range. On the other hand, for temperatures in the range of [COLD, RT], the current IZTAT may be larger than the current IPTAT_BRT, and therefore any excess current IZTAT-IPTAT_BRT that cannot be sinked by the current source IPTAT_BRT flows through the diode connected transistor T445A. This is shown in the current I_{445A} profile graph in FIG. 6A (upper right corner), where at the temperature point COLD, the excess current is INOM−0=INOM=I_{445A}, and converges to a value of zero at the temperature point RT while following a curve having a slope that is equal, in absolute value, to the slope of the IPTAT_BRT profile. As a result, the quadrant extraction circuit (440a) generates a current I_{445A} having a profile segment IC according to a slope of the input current IPTAT_BRT, and a profile segment IH with a constant zero value.

With reference to FIG. 6B, the currents IPTAT_ ART and IZTAT provided to the circuit (440b) are made to be in series connection through a common node N1b, and a diode connected transistor T445B coupled to the common node N1b determines direction of a current (I_{445B}) out of the common node N1b and through the transistor. Principle of operation of such circuit is similar to one described above in details with reference to FIG. 6A. In the particular case of the circuit (440b), the current I_{445B} is non-zero only when the current IPTAT_ART is larger than the current IZTAT. As a result, the quadrant extraction circuit (440b) generates a current I_{445B} having a profile segment IH according to a slope of the input current IPTAT_ART, and a profile segment IC with a constant zero value.

FIG. 6C shows details of the quadrant combinator block (450) depicted in FIG. 4B according to an exemplary embodiment of the present disclosure. The currents I_{445A} and I_{445B} representing the slopes extracted by the quadrant extraction block (440), and described above as related to FIGS. 6A (circuit 440a) and 6B (circuit 440b), are mirrored by connecting nodes NCRT_BRT and NPRT_ART to gates of transistors T445A′ and T445B′. As transistors T445A′ and T445B′ are coupled to a common node N1c, the combination of such transistors effectively creates a current source between the common node N1c and ground that can sink a current having a profile segment IC provided by the current I_{445A} and a profile segment IH provided by the current I_{445B}. Similar to operation of the circuits described in relation to FIGS. 6A and 6B, a diode connected transistor T445C coupled to the common node N1c determines direction of a current I_{445C} flowing out of the common node N1c and through the transistor T445C. For temperatures in the range of [COLD, RT], the current I_{445C} is non-zero when the current IZTAT is larger than the current I_{445A} flowing through transistor T445A′, and for temperatures in the range of [RT, HOT], the current I_{445C} is non-zero when the current IZTAT is larger than the current I_{445B} flowing through transistor T445B′. In turn, the current I_{445C} can be mirrored/sized via transistor T445C′ to provide the output current I_{B}. As can be seen in the profile graph depicted in FIG. 6C (lower graph), the quadrant combinator block (450) generates a current I_{B}, denoted IPTAT_CTAT, having a profile segment IC according to a PTAT profile, and a profile segment IH according to CTAT profile.

FIG. 6D shows details of the quadrant combinator & slope adjuster block (450′) depicted in FIG. 4D according to an exemplary embodiment of the present disclosure. The currents I_{445A} and I_{445B} representing the slopes extracted by the quadrant extraction block (440) and described above as related to FIGS. 6A (circuit 440a) and 6B (circuit 440b), are mirrored by connecting nodes NCRT_BRT and NPRT_ART to gates of transistors T445A″ and T445B″, so to provide operation of combining currents as described above with reference to FIG. 6C. However, since in the case of the block diagram (400D) of FIG. 4D, the slopes extracted by the quadrant extraction block (440) have not been adjusted (e.g., by slope adjuster 430), such slopes do not represent desired slopes for the current I_{B}, and therefore, according to an embodiment of the present disclosure, the mirroring of the currents I_{445A} and I_{445B} includes multiplication (e.g., amplification) of such currents via the variable size transistors T445A″ and T445B″ so to operate over multiplied currents Na*I_{445A} and Nb*I_{445B}, where Na and Nb represent respective multiplicative factors. According to an exemplary embodiment of the present disclosure, the multiplicative factors Na and Nb can be provided by mirroring the currents via the variable size transistors T445A″ and T4454B″, each such transistor comprising a plurality of parallel transistors which can be selectively activated for current conduction through respective switches S445A″ and S445B″. A person skilled in the art is well aware of such design techniques for multiplication of a current through mirroring. Further related description to current mirroring and multiplication can be found, for example, in the above referenced U.S. patent application Ser. No. 15/258,806, the disclosure of which is incorporated herein by reference in its entirety.

Based on the above description of FIGS. 6A, 6B, 6C and 6D, a person skilled in the art would realize that according to such exemplary embodiments of the present disclosure, the quadrant extraction block (440a, 440b) performs current subtraction with rectification, where rectification is performed through the diode connected transistors T445A and T445B. On the other hand, for the case described in FIG. 6C, the quadrant combinator block (450) performs the same current subtraction and rectification as performed by the quadrant extraction block (440a, 440b) but applied to a sum of currents (e.g. I_{444A}, I_{445B}). Finally, for the case described in FIG. 6D, the quadrant combinator & slope adjuster block (450′) performs the same current subtraction and rectification as performed by the quadrant extraction block (440a, 440b) but applied to a sum of currents (e.g. Na*I_{444A}, Nb*I_{445B}).

According to an embodiment of the present disclosure, the quadrant combinator block (450) and the quadrant combinator & slope adjuster block (450′) can be programmed to perform specific combinations of operations including i) current subtraction with rectification and ii) current summation, under control of a control signal (e.g. QC_Ctrl of FIG. 4B) to output the current I_{B} having any one of the nine basic profiles depicted in FIGS. 3A, 3B and 3C, with slopes of corresponding profile segments IC and IH according to the output of the slope adjuster block (430). According to an exemplary embodiment of the present disclosure, the nine basic profiles can be obtained through the following combinations of operations performed by the quadrant combinator block (450) or the quadrant combinator & slope adjuster block (450′):
PTAT_PTAT=(IZTAT [symbol] NCRT_BRT)+NPRT_ART
PTAT_ZTAT=(IZTAT [symbol] NCRT_BRT)
PTAT_CTAT=((IZTAT [symbol] (NCRT_BRT+NPRT_ART))
ZTAT_PTAT=(IZTAT+NPRT_ART)
ZTAT_ZTAT=IZTAT
ZTAT_CTAT=(IZTAT [symbol] NPRT_ART)
CTAT_PTAT=(IZTAT+NCRT_BRT+NPRT_ART)
CTAT_ZTAT=(IZTAT+NCRT_BRT)
CTAT_CTAT=(IZTAT [symbol] NPRT_ART)+NCRT_BRT
   where the operator “ [symbol] ” represents subtraction with rectification (as exemplified in FIGS. 6A and 6B), and where NCRT_BRT and NPRT_ART represent currents generated by the quadrant extraction block (440a, 440b). For example, for the case of the basic current profile PTAT_CTAT described with respect to FIG. 6C, NCRT_BRT is the current I_{445A} of FIG. 6C and NPRT_ART is the current I_{445B} of FIG. 6C. Accordingly, the currents NCRT_BRT and NPRT_ART are provided by the following combinations of operations performed by the quadrant extraction block (440a, 440b):
NCRT_BRT=IZTAT [symbol] IPTAT
NPRT_ART=IPTAT [symbol] IZTAT

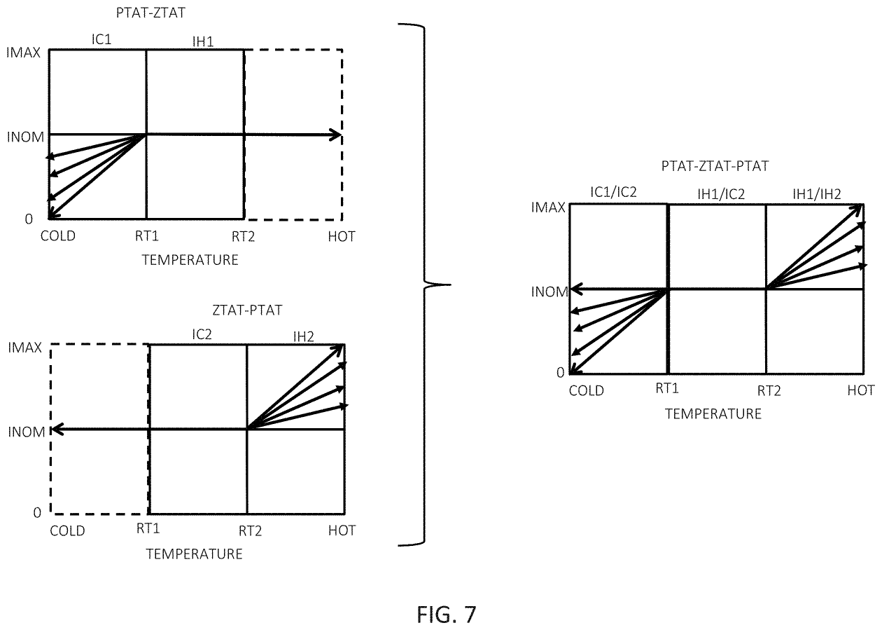

Based on the above description, a person skilled in the art would realize that further segmentation (e.g. beyond IC and IH) of the programmable temperature profile according to the present teachings may be possible, where a plurality of reference temperatures can define inflection points of the programmable output profile as exemplified in FIG. 7, where two basic temperature profiles PTAT-ZTAT and ZTAT-PTAT each having an inflection point at respective different temperatures RT1, RT2, are used to generate a programmable temperature profile (e.g. PTAT-ZTAT-PTAT) having two inflection points at the temperatures (RT1, RT2). Such flexibility and scalability of the design can allow for added flexibility in the control and optimization of an electronic device (e.g. PA, LNA) whose performance is sensitive to variation in temperature or, as described below, to variation of other parameters, such as, for example, voltage or environmental parameters provided by various sensors.

Such performance may be measured, for example, in terms of output power, gain, power added efficiency (PAE), output linearity, distortion (harmonic), or any other performance parameters that may be affected by temperature and compensated for by current adjustment. The programmable temperature profile according to the present disclosure may also be used to compensate for different performance parameters of an electronic device over different profile segments (temperature sub-ranges), for example, in a first segment (e.g. IC), provide a profile slope that optimizes gain of the device, and in a second segment (e.g. IH), provide a profile slope that optimizes output linearity of the device. Design goals and system implementation may dictate specific profiles to be used, either in static or dynamic fashion.

Finally, it should be noted that the teachings according to the present disclosure may also be used to control and optimize performance of electronic devices based on variations other than temperature, such as, for example, a battery voltage, or any other measurable parameter, by way of corresponding sensors, that may affect the performance of the electronic devices and which may be compensated for by adjustment of current to the electronic devices. In such cases, programmable output current profiles based on values of the measurable parameter instead of temperature may be provided based on the present teachings. A person skilled in the art would know how to apply methods and devices according to the present teachings accordingly.

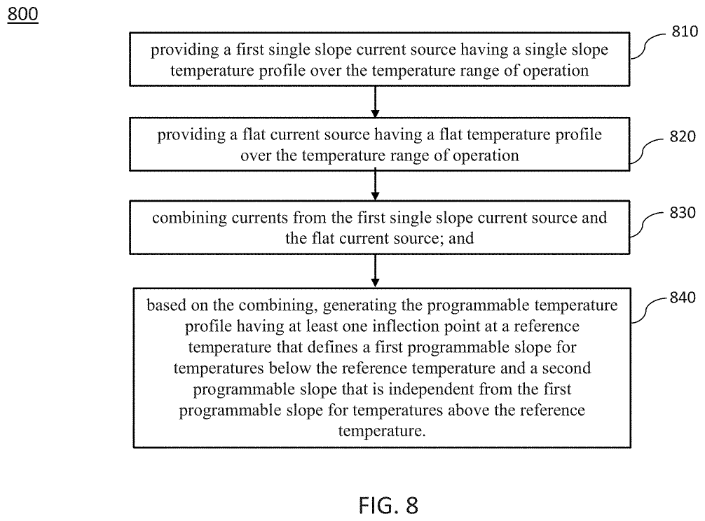

FIG. 8 is a process chart showing various steps of a method for generating a programmable temperature profile over a temperature range of operation, according to an embodiment of the present disclosure. As can be seen in the process chart (800), the method comprises: providing a first single slope current source having a single slope temperature profile over the temperature range of operation, per step (810); providing a flat current source having a flat temperature profile over the temperature range of operation (per step 820); combining currents from the first single slope current source and the flat current source, per step (830); and based on the combining, generating the programmable temperature profile having at least one inflection point at a reference temperature that defines a first programmable slope for temperatures below the reference temperature and a second programmable slope that is independent from the first programmable slope for temperatures above the reference temperature, per the last step (840).

The term “MOSFET”, as used in this disclosure, means any field effect transistor (FET) with an insulated gate and comprising a metal or metal-like-insulator-semiconductor structure. The terms “metal” or “metal-like” include at least one electrically conductive material (such as aluminum, copper, or other metal, or highly doped polysilicon or silicide, graphene, or other electrical conductor), “insulator” comprises at least one insulating material (such as silicon dioxide, or other dielectric material), and “semiconductor” comprises at least one semiconductor material (such as silicon).

As should be readily apparent to one of ordinary skill in the art, various embodiments of the invention can be implemented to meet a wide variety of specifications. Unless otherwise noted above, selection of suitable component values is a matter of design choice and various embodiments of the invention may be implemented in any suitable IC technology (including but not limited to MOSFET structures), or in hybrid or discrete circuit forms. Integrated circuit embodiments may be fabricated using any suitable substrates and processes, including but not limited to standard bulk silicon, silicon-on-insulator (SOI), and silicon-on-sapphire (SOS). Unless otherwise noted above, the invention may be implemented in other transistor technologies such as bipolar, GaAs HBT, GaN HEMT, GaAs pHEMT, and MESFET technologies. However, the inventive concepts described above are particularly useful with an SOI-based fabrication process (including SOS), and with fabrication processes having similar characteristics. Fabrication in CMOS on SOI or SOS enables low power consumption, the ability to withstand high power signals during operation due to FET stacking, good linearity, and high frequency operation (i.e., radio frequencies up to and exceeding 50 GHz). Monolithic IC implementation is particularly useful since parasitic capacitances generally can be kept low (or at a minimum, kept uniform across all units, permitting them to be compensated) by careful design.

Voltage levels may be adjusted or voltage and/or logic signal polarities reversed depending on a particular specification and/or implementing technology (e.g., NMOS, PMOS, or CMOS, and enhancement mode or depletion mode transistor devices). Component voltage, current, and power handling capabilities may be adapted as needed, for example, by adjusting device sizes, serially “stacking” components (particularly FETs) to withstand greater voltages, and/or using multiple components in parallel to handle greater currents. Additional circuit components may be added to enhance the capabilities of the disclosed circuits and/or to provide additional functional without significantly altering the functionality of the disclosed circuits.

A number of embodiments of the invention have been described. It is to be understood that various modifications may be made without departing from the spirit and scope of the invention. For example, some of the steps described above may be order independent, and thus can be performed in an order different from that described. Further, some of the steps described above may be optional. Various activities described with respect to the methods identified above can be executed in repetitive, serial, or parallel fashion.

It is to be understood that the foregoing description is intended to illustrate and not to limit the scope of the invention, which is defined by the scope of the following claims, and that other embodiments are within the scope of the claims. (Note that the parenthetical labels for claim elements are for ease of referring to such elements, and do not in themselves indicate a particular required ordering or enumeration of elements; further, such labels may be reused in dependent claims as references to additional elements without being regarded as starting a conflicting labeling sequence).

1. A current generator circuit with programmable temperature profile over a temperature range of operation, the current generator circuit comprising:
a first single slope current source having a single slope temperature profile over the temperature range of operation;
a flat current source having a flat temperature profile over the temperature range of operation;
wherein the current generator circuit is configured to generate the programmable temperature profile based on combinations of currents from the first single slope current source and the flat current source, the programmable temperature profile having at least one inflection point at a reference temperature that defines a first programmable slope for temperatures below the reference temperature and a second programmable slope that is independent from the first programmable slope for temperatures above the reference temperature, and
wherein each of the two separate programmable slopes can be programmed to be any one of: a) a positive slope, b) a negative slope, and c) a flat slope with respect to a positive variation of temperature within the temperature range of operation.

2. The current generator circuit according to claim 1, wherein the flat temperature profile is based on an adjustment of the single slope temperature profile of the first single slope current source.

3. The current generator circuit according to claim 1, wherein:
the first single slope current source and the flat current source are respectively based on a combination of a plurality of elementary single slope current sources and a combination of a plurality of elementary flat current sources, and
wherein each of the first and second programmable slopes are based on a combination of different numbers of elementary current sources from the plurality of elementary single slope current sources and different numbers of elementary current sources from the plurality of elementary flat current sources.

4. The current generator circuit according to claim 3, wherein each elementary current source from the plurality of elementary single slope current sources and from the plurality of elementary flat current sources have a same nominal current value at the reference temperature.

5. The current generator circuit according to claim 4, wherein the first single slope current source and the flat current source have a same reference current value at the reference temperature.

6. The current generator circuit according to claim 1, wherein the current generator circuit is further configured to perform at least one of a current subtraction with rectification operation and a current summation operation to generate an output current having the programmable temperature profile over the temperature range of operation.

7. The current generator circuit according to claim 6, wherein the current generator circuit is configured to perform the current subtraction with rectification operation according to the following:
a1) through a first current subtraction with rectification operation, subtract a first current having one of the first programmable slope and the second programmable slope over the temperature range of operation from a second current having the flat temperature profile over the temperature range of operation, temperature profiles of the first and the second currents intersecting at the reference point defined by the reference temperature and a reference current value, and rectify a resultant current from the subtraction to obtain a first extracted current with a temperature profile that is flat for temperature values over the reference temperature and has an extracted first slope, based on the first programmable slope, for temperature values below the reference temperature.

8. The current generator circuit according to claim 7, wherein the current generator circuit is further configured to perform the current subtraction with rectification operation according to the following:
a2) through a second current subtraction with rectification operation, subtract the second current from a third current having the other of the first programmable slope and the second programmable slope over the temperature range of operation, temperature profiles of the second and the third current intersecting at the reference point, and rectify a resultant current from the subtraction to obtain a second extracted current with a temperature profile that is flat for temperature values below the reference temperature and has an extracted second slope, based on the second programmable slope, for temperature values above the reference temperature.

9. The current generator circuit according to claim 8, wherein the current generator circuit is further configured to combine, through one or more of the current summation operation and the subtraction with rectification operation, the second current with the flat temperature profile with one or both of the first extracted current and the second extracted current, to generate an output current having the programmable temperature profile over the temperature range of operation.

10. The current generator circuit according to claim 7, wherein the programmable temperature profile can be selected to encompass:
b1) for temperature values below the reference temperature, the flat temperature profile of the second current, or a slope based on the extracted first slope that passes through a point that is above or below the reference current value; and
b2) for temperature values above the reference temperature, the flat temperature profile of the second current, or a slope based on the extracted second slope that passes through a point that is either above or below the reference current value.

11. The current generator circuit according to claim 6, wherein the current subtraction with rectification operation is performed by a circuit of the current generator circuit that comprises:
a first current source coupled to a supply voltage, the first current source sourcing a first current;
a second current source coupled to a reference voltage, the second current source in series connection with the first current source through a common node connection between the first and second current sources, the second current source sinking a second current; and
a diode connected transistor with a drain node and gate node that are connected to the common node connection between the first and second current source, and a source node that is coupled to the reference voltage,
wherein when the first current is larger than the second current, a current equal to a difference between the first current and the second current flows through the diode connected transistor, and
wherein when the first current is smaller than the second current, no current flows through the diode connected transistor.

12. The current generator according to claim 11, wherein further operations on the current through the diode connected transistor generated by the current subtraction with rectification operation is provided by a mirroring circuit comprising a transistor whose gate is connected to the gate of the diode connected transistor so that a current through said transistor is proportional to the current through the diode connected transistor.

13. The current generator circuit according to claim 6, wherein the current generator circuit is configured to perform the current subtraction with rectification operation according to the following:
a1) through a first current subtraction with rectification operation, subtract a first current having a first slope associated to the first programmable slope over the temperature range of operation from a second current having the flat temperature profile over the temperature range of operation, temperature profiles of the first and the second currents intersecting at the reference point defined by the reference temperature and a reference current value, and rectify a resultant current from the subtraction to obtain a first extracted current with a temperature profile that is flat for temperature values over the reference temperature and has an extracted first slope, associated to the first programmable slope, for temperature values below the reference temperature.

14. The current generator circuit according to claim 13, wherein the current generator circuit is further configured to perform the current subtraction with rectification operation according to the following:
a2) through a second current subtraction with rectification operation, subtract the second current from a third current having a second slope associated to the second programmable slope over the temperature range of operation, temperature profiles of the second and the third current intersecting at the reference point, and rectify a resultant current from the subtraction to obtain a second extracted current with a temperature profile that is flat for temperature values below the reference temperature and has an extracted second slope, associated to the second programmable slope, for temperature values above the reference temperature.

15. The current generator circuit according to claim 14, wherein the current generator circuit is further configured to combine, through one or more of the current summation operation and the subtraction with rectification operation, the second current with the flat temperature profile with amplified versions of one or both of the first extracted current and the second extracted current, to generate an output current having the programmable temperature profile over the temperature range of operation.

16. The current generator circuit according to claim 15, wherein the amplified versions are generated by current mirroring of respective first and second extracted currents.

17. The current generator circuit according to claim 16, wherein the current mirroring comprises a variable size transistor whose size is adjusted to provide the first or second programmable slopes.

18. A method for generating a programmable temperature profile over a temperature range of operation, the method comprising:
providing a first single slope current source having a single slope temperature profile over the temperature range of operation;
providing a flat current source having a flat temperature profile over the temperature range of operation;
combining currents from the first single slope current source and the flat current source; and
based on the combining, generating the programmable temperature profile having at least one inflection point at a reference temperature that defines a first programmable slope for temperatures below the reference temperature and a second programmable slope that is independent from the first programmable slope for temperatures above the reference temperature,
wherein each of the two separate programmable slopes can be programmed to be any one of: a) a positive slope, b) a negative slope, and c) a flat slope with respect to a positive variation of temperature within the temperature range of operation.

19. The method according to claim 18, wherein the providing of the flat current source comprises adjusting of the single slope temperature profile of the first single slope current source to generate the flat temperature profile of the flat current source.

20. The method according to claim 18, wherein the combining comprises:
combining current portions of the first single slope current source and current portions of the flat current source to generate a current profile having the first programmable slope over the temperature range of operation that has a reference current value at the reference temperature; and
combining current portions of the first single slope current source and current portions of the flat current source to generate a current profile having the second programmable slope over the temperature range of operation that has the reference current value at the reference temperature.

21. The method according to claim 18, wherein the generating comprises:
performing a current summation of a current having the flat temperature profile over the temperature range of operation and a current having a profile with one of the first programmable slope and the second programmable slope over the temperature range of operation.

22. The method according to claim 18, wherein the generating comprises:
performing a current subtraction with rectification operation of a current having the flat temperature profile over the temperature range of operation and a current having a profile with one of the first programmable slope and the second programmable slope over the temperature range of operation.

23. The method according to claim 22, wherein the performing of the current subtraction with rectification comprises:
series connecting a first current source generating a first current and a second current source generating a second current through a common node connection between the first and second current sources;
connecting a drain node and a gate node of a diode connected transistor to the common node connection;
obtaining, when the first current is larger than the second current, a current flow through the diode connected transistor that is equal to a difference between the first current and the second current; and
obtaining, when the first current is smaller than the second current, no current flow through the diode connected transistor.

24. The method according to claim 23, wherein the first current has the flat temperature profile over the temperature range of operation and the second current has the profile with one of the first programmable slope and the second programmable slope over the temperature range of operation.

25. The method according to claim 23, wherein the first current has the profile with one of the first programmable slope and the second programmable slope over the temperature range of operation and the second current has the flat temperature profile over the temperature range of operation.

26. The current generator circuit according to claim 1,
wherein the programmable temperature profile includes an additional inflection point at a reference temperature that is different from the reference temperature of the at least one inflection point, the additional inflection point defining a third programmable slope that is independent from the first and the second programmable slopes for temperatures above the reference temperature of the additional inflection point, and
wherein the third programmable slope can be programmed to be any one of a positive slope, a negative slope, and a flat slope with respect to the positive variation of temperature within the temperature range of operation.

27. The current generator circuit according to claim 26,
wherein the reference temperature of the at least one inflection point is below the reference temperature of the additional inflection point, and
wherein the first programmable slope has a negative slope, the second programmable slope has a flat slope, and the third programmable slope has a positive slope.
